(19) United States
(12) Patent Application Publication
(10) Pub. No.: US 2017/0096955 A1
(43) Pub. Date: Apr. 6, 2017

(54) METHOD FOR CONTROLLING EXHAUST GAS RECIRCULATION SYSTEM OF VEHICLE

(71) Applicants: HYUNDAI MOTOR COMPANY, Seoul (KR); KIA MOTORS CORPORATION, Seoul (KR)

(72) Inventor: Do Geun JUNG, Suwon-Si (KR)

(21) Appl. No.: 15/076,290

(22) Filed: Mar. 21, 2016

(30) Foreign Application Priority Data
Oct. 6, 2015 (KR) 10-2015-0140387

(51) Int. Cl. F02D 41/00; F02M 26/46; F02M 26/49; F01N 11/00

(52) U.S. Cl. CPC F02D 41/0055; F01N 11/00; F02M 26/46; F02M 26/49

(57) ABSTRACT

A method for controlling an exhaust gas recirculation (EGR) system includes a first step of determining whether the EGR system is in an operation section under an ignition-on state, a second step of calculating a catalyst deterioration index with catalyst deterioration-diagnosing logic in a section that is determined to be the operation section of the EGR system, and for sensing an occurrence of a misfire in an engine with misfire-sensing logic, a third step of deciding whether the catalyst deterioration index is abnormal on a basis of a first predetermined value and whether a frequency of the misfire is abnormal on basis of a preset value for a reference duration, and a fourth step of controlling an opening amount of an EGR valve based on the decision of the abnormality of both the catalyst deterioration index and the misfire frequency.

### CROSS REFERENCE TO RELATED APPLICATION

The present application claims the benefit of priority to Korean Patent Application No. 10-2015-0140387, filed on Oct. 6, 2015 with the Korean Intellectual Property Office, the entire content of which is incorporated herein for all purposes by this reference.

### TECHNICAL FIELD

The present disclosure generally relates to a method for controlling an Exhaust Gas Recirculation (EGR) system of a vehicle and, more particularly, to an EGR system control method of a vehicle in which the opening amount of an EGR valve is controlled by determining whether a catalyst is damaged.

### BACKGROUND

An EGR system is a system for recirculating a portion of exhaust gas from an engine combustion chamber into the air intake line of an engine, and involves technology for reducing nitrogen oxide, which is easily generated under the conditions of a high temperature and high oxygen concentration.

FIG. 1 is a concept diagram illustrating an example of an EGR system of a vehicle.

As illustrated in FIG. 1, the EGR system of a general vehicle may include: an engine 10; an intake manifold 20 for drawing air for combustion into the engine 10; an exhaust manifold 30 for discharging an exhaust gas combusted in the engine; a catalyst 40, installed in the exhaust manifold 30, for purifying harmful substances included in the exhaust gas; an EGR pipe 50, installed at the rear end of the catalyst 40, for recirculating the exhaust gas of which the harmful substances are purified into the intake manifold 20; and an EGR valve 60, installed in the EGR pipe 50, for regulating the flow rate of the exhaust gas recirculated to the EGR pipe 50. Accordingly, the flow rate of the exhaust gas is regulated by the control of the EGR valve 60 through an Electronic Control Unit (ECU) 70.

The reason why the exhaust gas is recirculated to the intake manifold 20 by connecting the EGR pipe 50 to the rear end of the catalyst 40 is that damage to the engine 10, the deposition of the foreign substances in the intake valve, and self-ignition of the foreign substances may be prevented by injecting the exhaust gas, from which harmful substances and foreign substances are purified through the catalyst 40, into the intake manifold 20 to be recirculated.

Such a configuration of the EGR system, namely, connecting the EGR pipe 50 to the rear end of the catalyst 40 may have the above-mentioned advantages. However, cells inside the catalyst 40 may be damaged by melting and aging, or may be fragmented by the exhaust gas and eliminated to the rear of the catalyst 40.

When the EGR valve 60 is operating under such conditions, the foreign substances flow into the engine 10. This may cause the EGR pipe 50, a cooler (not illustrated), the EGR valve 60, and the intake valve of the engine to clog, and cause misfires and knocking by failing to control the flow rate, which may lead to an adverse situation such as damaging or stopping the engine 10.

The foregoing is intended merely to aid in the understanding of the background of the present disclosure, and is not intended to mean that the present disclosure falls within the purview of the related art that is already known to those skilled in the art.

### SUMMARY OF THE DISCLOSURE

The present disclosure provides a method for controlling an EGR system of a vehicle in which whether a catalyst is damaged is determined by detecting the degree of catalyst deterioration and whether an engine misfire occurs, and the opening amount of an EGR valve is controlled by the determination.

A method for controlling an EGR system of a vehicle according to an embodiment of the present disclosure is a method for regulating a flow rate of a circulating exhaust gas with an ECU in a vehicle to which a catalyst and the EGR system are applied, and the method includes: a first step for determining whether the EGR system is in an operation section under an ignition-on state; a second step for calculating a catalyst deterioration index with catalyst deterioration-diagnosing logic in a section that is determined to be the operation section of the EGR system, and for sensing occurrence of a misfire in an engine with misfire-sensing logic; a third step for deciding whether the catalyst deterioration index calculated in the second step is abnormal on basis of a first predetermined value and whether frequency of the misfire is abnormal on basis of a preset value for a reference duration; and a fourth step for controlling an opening amount of an EGR valve based on the decision for the abnormality of both the catalyst deterioration index and the misfire frequency, as measured in the third step.

The second step for calculating the catalyst deterioration index with the catalyst deterioration-diagnosing logic may be achieved by: measuring an oxygen concentration of the exhaust gas at an front end and a rear end of the catalyst; and calculating the catalyst deterioration index by comparing a value of a peak-to-peak amplitude of the oxygen concentration measured at the front end of the catalyst with a value of a peak-to-peak amplitude of the oxygen concentration measured at the rear end of the catalyst.

The catalyst deterioration index of the second step may be calculated according to the following Equation (1):

$$Catalyst deterioration index = \frac{amplitude of oxygen {concentration}_{rear}}{amplitude of oxygen {concentration}_{front }} \qquad ( 1 )$$

wherein ‘amplitude of oxygen concentrationᵣₑₐᵣ’ denotes the amplitude of the oxygen concentration measured from the exhaust gas at the rear end of the catalyst, and ‘amplitude of oxygen concentration_{front}’ denotes the amplitude of the oxygen concentration measured from the exhaust gas at the front end of the catalyst.

The second step for sensing the occurrence of a misfire in an engine with the misfire-sensing logic may be achieved by: calculating a duration on a segment basis by detecting a change in a crank angle of the engine; calculating an engine roughness on a cylinder basis by using the calculated duration on a segment basis; and determining to be a misfire when the calculated engine roughness is equal to or greater than a second predetermined value.

The EGR valve may be blocked when both the catalyst deterioration index and the frequency of the misfire are determined to be abnormal in the fourth step.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a block diagram illustrating an example of an EGR system of a vehicle;

FIG. 2 is a flowchart illustrating a method for controlling an EGR system of a vehicle according to an embodiment of the present disclosure; and

FIG. 3 is a graph showing the amplitude of oxygen concentrations measured by oxygen sensors at the front end and rear end of a catalyst.

### DETAILED DESCRIPTION OF THE DISCLOSURE

The disclosure will now be described more fully hereinafter with reference to the accompanying drawings, in which exemplary embodiments of the disclosure are shown. The present disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. The same reference numerals refer to similar elements throughout.

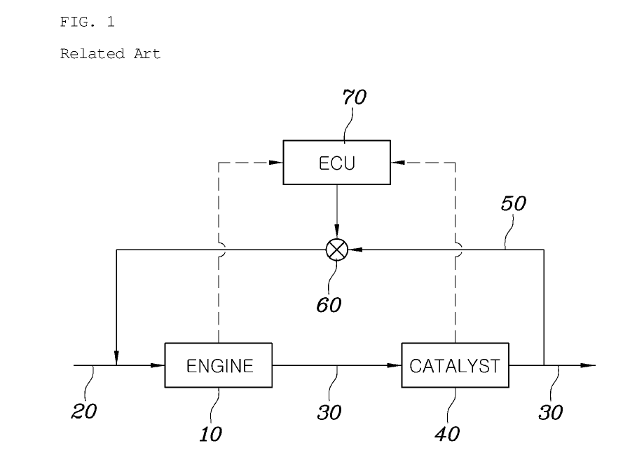

First, a method for controlling an EGR system of a vehicle according to an embodiment of the present disclosure is a method for regulating the flow rate of a circulating exhaust gas in a vehicle to which a catalyst and the EGR system are applied, as shown in FIG. 1.

As described above, referring to a vehicle to which a catalyst and an EGR system is applied, the EGR system of a general vehicle may include: an engine 10; an intake manifold 20 for sucking air for combustion into the engine 10; an exhaust manifold 30 for discharging an exhaust gas combusted in the engine; a catalyst 40 installed in the exhaust manifold 30, for purifying harmful substances included in the exhaust gas; an EGR pipe 50 installed at the rear end of the catalyst 40 for recirculating the exhaust gas from which the harmful substances are purified into the intake manifold 20; and an EGR valve 60 installed in the EGR pipe 50 for regulating the flow rate of the exhaust gas recirculated to the EGR pipe 50. Accordingly, the flow rate of the exhaust gas is regulated by the control of the EGR valve 60 through an Electronic Control Unit (ECU) 70.

Specifically, air for combustion may be sucked into the engine 10 through the intake manifold 20 and then combusted. The exhaust gas from the combustion may be discharged through the exhaust manifold 30. While the exhaust gas, discharged to the exhaust manifold 30, is passing through the catalyst 40, harmful substances may be purified from the exhaust gas. Some of the exhaust gas from which the harmful substances are purified may be recirculated to the intake manifold 20 via the EGR pipe 50. In this case, the flow rate of the exhaust gas, recirculated to the intake manifold 20 via the EGR pipe 50, may be regulated whereby the ECU 70 controls the opening amount of the EGR valve 60, which is installed in the EGR pipe 50.

Meanwhile, the catalyst 40 may be damaged. For example, when a gas that has not combusted due to an engine misfire ignites at the front end of the catalyst 40, the catalyst 40 may be melted, or when the internal parts of the catalyst 40 are aged, a part damaged from the exhaust gas may be eliminated from, or separate from, the catalyst 40 and discharged to the rear end of the catalyst 40.

The method for controlling an EGR system according to the present disclosure is proposed based on the fact that foreign substances eliminated from the catalyst 40 may be prevented from flowing into the engine 10 by stopping or restricting the control of the EGR valve 60 when aging of the catalyst 40 and the misfire of the engine 10 are detected.

A method for controlling an EGR system according to an embodiment of the present disclosure, which is applied to the above-mentioned configuration, will be described with reference to the drawing.

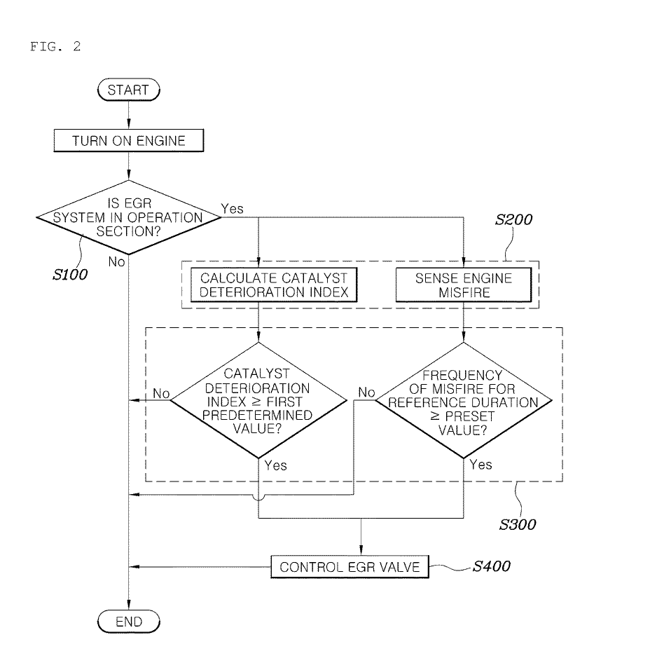

FIG. 2 is a flowchart illustrating a method for controlling an EGR system of a vehicle according to an embodiment of the present disclosure.

First, as illustrated in FIG. 2, the ECU 70 may determine whether the EGR system is in an operation section under an ignition-on state in the first step (S100). Here, the operation of the EGR system may indicate the operation of a mode in which the exhaust gas discharged from the engine 10 is purified by the catalyst 40 and some of the exhaust gas is recirculated to the intake manifold 20 via the EGR pipe 50.

Accordingly, in the second step (S200), a catalyst deterioration index may be calculated in the section that is determined to be the operation section of the EGR system, and an engine misfire is sensed.

The calculation of the catalyst deterioration index may calculate a degree of deterioration with catalyst deterioration-diagnosing logic, and the process may be performed by measuring an oxygen concentration included in the exhaust gas from the front end and rear end of the catalyst 40 and by comparing the peak-to-peak amplitude of the oxygen concentration measured at the front end of the catalyst 40 with that measured at the rear end of the catalyst 40.

For example, the catalyst deterioration index may be calculated by the following Equation (1):

$$Catalyst deterioration index = \frac{amplitude of oxygen {concentration}_{rear}}{amplitude of oxygen {concentration}_{front }} \qquad ( 1 )$$

wherein ‘amplitude of oxygen concentrationᵣₑₐᵣ’ denotes the amplitude of the oxygen concentration measured from the exhaust gas at the rear end of the catalyst 40, and ‘amplitude of oxygen concentration_{front}’ denotes the amplitude of the oxygen concentration measured from the exhaust gas at the front end of the catalyst 40.

Meanwhile, sensing the engine misfire means sensing the occurrence of a misfire in the engine with misfire-sensing logic. Specifically, a duration on a segment basis may be calculated by detecting a change in a crank angle of the engine 10, an engine roughness on a cylinder basis is calculated using the calculated duration on a segment basis, a misfire may be determined when the calculated engine roughness on a cylinder basis is equal to or greater than a predetermined value (a second predetermined value), and the frequency of a misfire is detected. Here, the predetermined value may be set according to various kinds of engines, for example, according to an engine type, the displacement of an engine, and the like.

When, through the above-mentioned processes, the catalyst deterioration index is calculated and the frequency of the engine misfire is acquired, whether the catalyst deterioration index is abnormal and whether the frequency of the misfire is abnormal may be determined respectively using the calculated catalyst deterioration index and the acquired engine misfire frequency in the third step (S300).

Whether the catalyst deterioration index is abnormal may determine whether the catalyst deterioration index calculated in the second step is equal to or greater than a predetermined value (the first predetermined value), and when the calculated catalyst deterioration index is equal to or greater than the predetermined value (the first predetermined value), it may be determined that the catalyst is abnormal due to the deterioration of the catalyst.

Also, whether the frequency of the misfire is abnormal may be determined by whether the frequency of the engine misfire, acquired in the second step, is equal to or greater than a preset value for a reference duration. When the frequency of the misfire is equal to or greater than the preset value, it may be determined to be abnormal because too many misfires occur in the engine.

Here, whether both the catalyst deterioration index and the frequency of the misfire are abnormal may be determined because one of various causes of a misfire in the engine is that foreign substances, generated by the deterioration (aging) of the catalyst 40, are recirculated by the EGR system and flow in the engine. Accordingly, the present disclosure may acquire data about an engine misfire occurring due to the deterioration (aging) of the catalyst 40, and regulate the flow rate of the exhaust gas recirculated in the EGR system depending on the data. Therefore, it may be necessary to determine whether both the catalyst deterioration index and the frequency of the misfire are abnormal.

The opening amount of the EGR valve 60 may be controlled by determining whether both the catalyst deterioration index and the frequency of the misfire are abnormal, and as a result, the flow rate of the exhaust gas recirculated to the engine 10 may be regulated in the fourth step (S400).

The control of the opening amount of the EGR valve 60 in the fourth step may make the flow rate of the recirculated exhaust gas become ‘0’ by completely blocking the EGR valve 60, or may reduce the flow rate of the exhaust gas to be less than that at the time at which the EGR valve 60 starts to be operated. Either to completely block the EGR valve 60 or to reduce the opening amount thereof may be determined by an EGR operating condition, which may be predetermined according to the degree of abnormality of the catalyst deterioration index and the frequency of the misfire.

However, in consideration of the problems that occur when foreign substances from the catalyst 40 flow in the engine 10, it may be desirable to completely block the EGR valve 60 to completely shut off the exhaust gas recirculated to the engine 10 when it is determined that both the catalyst deterioration index and the frequency of the misfire are abnormal.

Hereinafter, in the method for controlling the EGR system of a vehicle using the above-mentioned processes, the process for calculating the catalyst deterioration index and the process for sensing the misfire of the engine will be described in detail.

First, oxygen sensors for measuring the oxygen concentration included in the exhaust gas may be installed at the front end and rear end of the catalyst 40 in order to calculate the catalyst deterioration index. In this case, the peak-to-peak amplitude of the oxygen concentration measured by the oxygen sensor installed at the front end may be used as ‘amplitude of oxygen concentration_{front}’ and that measured by the oxygen sensor installed at the rear end may be used as ‘amplitude of oxygen concentrationᵣₑₐᵣ’.

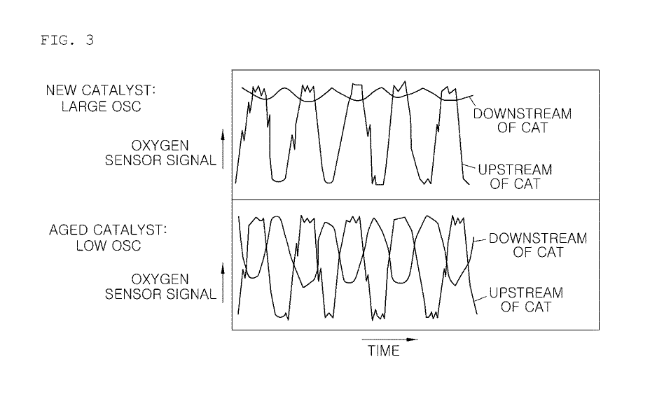

FIG. 3 is a graph showing the amplitudes of the oxygen concentrations respectively measured by the oxygen sensors at the front end and rear end of the catalyst, according to whether the catalyst is damaged. If the catalyst 40 is not damaged (as shown in the upper graph), ‘amplitude of oxygen concentration_{front}’ may have a relatively high value, but ‘amplitude of oxygen concentrationᵣₑₐᵣ’ may have a relatively low value. Accordingly, if the catalyst 40 is not damaged, the catalyst deterioration index calculated by Equation (1) may have a value close to, or equal to, ‘0’.

Conversely, when the catalyst 40 is damaged (as shown in the lower graph), ‘amplitude of oxygen concentration_{front}’ may have a relatively high value as in the case that the catalyst is not damaged, but ‘amplitude of oxygen concentrationᵣₑₐᵣ’ may also have a high value. Therefore, when the catalyst 40 is damaged, the catalyst deterioration index calculated by Equation (1) may have a value close to ‘1’. Also, as the degree of the damage of the catalyst 40 increases, the catalyst deterioration index calculated by Equation (1) may approach ‘1’.

Therefore, the present embodiment may determine the first predetermined value as 0.3. Accordingly, when the catalyst deterioration index calculated by Equation (1) is equal to or greater than 0.3, it may be determined that the catalyst deterioration index is abnormal.

Also, in order to sense whether the misfire of the engine 10 occurs using the misfire-sensing logic, the duration on a segment basis may be calculated using a crank angle sensor for detecting the speed of the engine 10 and using an engine controller for detecting a change in a crank angle measured by the crank angle sensor, and the engine roughness on a cylinder basis may be calculated from the calculated duration on a segment basis. Then, when the calculated engine roughness on a cylinder basis is equal to or greater than the second predetermined value, it may be determined to be a misfire.

The frequency of the misfire for the reference duration, for example, the number of times of the misfire while the crank of the engine 10 makes 1000 revolutions is equal to or greater than 3% of the total, it may be determined to be abnormal because the frequency of the misfire occurring in the engine 10 is excessive.

According to an embodiment of the present disclosure, the opening amount of an EGR valve may be controlled by detecting an engine misfire and aging of a catalyst, thus preventing foreign substances discharged from the catalyst from flowing into an engine.

Therefore, an EGR pipe, a cooler, an EGR valve, and the intake valve of an engine may be prevented from clogging, thus preventing an adverse situation such as the damaging or stopping of the engine.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A method for controlling an exhaust gas recirculation (EGR) system by regulating a flow rate of a circulating exhaust gas with an electronic control unit (ECU) in a vehicle to which a catalyst and the EGR system are applied, the method comprising:
a first step of determining whether the EGR system is in an operation section under an ignition-on state;
a second step of calculating a catalyst deterioration index with catalyst deterioration-diagnosing logic in a section that is determined to be the operation section of the EGR system, and for sensing an occurrence of a misfire in an engine with misfire-sensing logic;
a third step of deciding whether the catalyst deterioration index calculated in the second step is abnormal on a basis of a first predetermined value and whether a frequency of the misfire is abnormal on basis of a preset value for a reference duration; and
a fourth step of controlling an opening amount of an EGR valve based on the decision of the abnormality of both the catalyst deterioration index and the misfire frequency, as measured in the third step.

2. The method of claim 1, wherein the second step of calculating the catalyst deterioration index with the catalyst deterioration-diagnosing logic is achieved by:
measuring an oxygen concentration of the exhaust gas at a front end and a rear end of the catalyst; and
calculating the catalyst deterioration index by comparing a value of a peak-to-peak amplitude of the oxygen concentration measured at the front end of the catalyst with a value of a peak-to-peak amplitude of the oxygen concentration measured at the rear end of the catalyst.

3. The method of claim 2, wherein the catalyst deterioration index of the second step is calculated according to the following Equation (1):
$$Catalyst deterioration index = \frac{amplitude of oxygen {concentration}_{rear}}{amplitude of oxygen {concentration}_{front }} \qquad ( 1 )$$
wherein ‘amplitude of oxygen concentrationᵣₑₐᵣ’ denotes the amplitude of the oxygen concentration measured from the exhaust gas at the rear end of the catalyst, and ‘amplitude of oxygen concentration_{front}’ denotes the amplitude of the oxygen concentration measured from the exhaust gas at the front end of the catalyst.

4. The method of claim 1, wherein the second step of sensing the occurrence of a misfire in an engine with the misfire-sensing logic is achieved by:
calculating a duration on a segment basis by detecting a change in a crank angle of the engine;
calculating an engine roughness on a cylinder basis by using the calculated duration on a segment basis; and
determining a misfire when the calculated engine roughness is equal to or greater than a second predetermined value.

5. The method of claim 1, wherein the EGR valve is blocked when both the catalyst deterioration index and the frequency of the misfire are determined to be abnormal in the fourth step.
